(19) United States
(12) Patent Application Publication
(10) Pub. No.: US 2026/0326628 A1
(43) Pub. Date: Oct. 22, 2026

(54) GEAR UNIT FOR ADJUSTING A SEAT AND ADJUSTABLE SEAT UNIT, IN PARTICULAR FOR A VEHICLE

(71) Applicant: IMS Gear SE & Co. KGaA, Donaueschingen (DE)

(72) Inventors: Michael KAISER, Villingen-Schwenningen (DE); Manuel HENGSTLER, St. Georgen (DE); Eric STAEHLE, Bad Duerrheim (DE)

(21) Appl. No.: 19/544,134

(22) Filed: Feb. 19, 2026

(30) Foreign Application Priority Data
Apr. 16, 2025 (EP) 25170956.4

(51) Int. Cl. B60N 2/07; B60N 2/06

(52) U.S. Cl. CPC B60N 2/0722; B60N 2/067

(57) ABSTRACT

A gear unit (10) for adjusting a seat, in particular a vehicle seat, in particular longitudinally, with a gear mechanism (13) comprising a first gear wheel (20) with a first rotational axis (22) and a second gear wheel (24) meshing with the first gear wheel (20) and having a second rotational axis (26), and with a housing unit (14), wherein the housing unit (14) comprises a gear mechanism housing (16) in which the gear mechanism (13) is arranged, and at least one retaining element (18) for establishing a mechanical operative connection between the gear unit (10) and the seat, wherein the at least one retaining element (18) is integrally molded onto the gear mechanism housing (16), as well as an adjustable seat unit comprising a seat and a gear unit (10).

The invention relates to a gear unit for adjusting a seat and an adjustable seat unit, in particular for a vehicle.

Seat longitudinal adjustment devices are frequently used for the electrically motorized adjustment of seats in the longitudinal direction of a motor vehicle. Seat longitudinal adjustment devices usually have a spindle gear unit by means of which speed and torque are transmitted between a gear worm and a gear spindle. To this end, a spindle nut is arranged on the gear spindle and in turn has a toothed ring with external teeth in engagement with the gear worm. Such spindle gear units are known, for example, from EP 1 992 842 B1 , DE 103 62 040 B4 , DE 10 2004 046 048 B3 or KR 10 1 920 222 B1 .

As can be seen, in particular, from the two documents EP 1 992 842 B1 and DE 103 62 040 B4 , the spindle gear units for use in a seat longitudinal adjustment device can be arranged in a U-shaped gear mechanism retainer. The gear mechanism housing of the spindle gear unit is often held in the gear mechanism retainer by means of elastic bearing shells. The gear mechanism retainer can in turn be coupled to the seat that is to be adjusted. The spindle drive and the gear mechanism retainer as a whole must have sufficiently high strength to exert the necessary restraining force on the seat in the event of a so-called crash, i.e. an impact on the vehicle, especially a frontal impact.

Known solutions for seat longitudinal adjustment devices have a relatively high number of parts. Since seat longitudinal adjustment devices are usually manufactured in very large quantities, such systems involve correspondingly high costs, especially in assembly, but also in handling and the associated logistics.

It is the object of the invention is to provide an arrangement for adjusting a seat that has low manufacturing costs, high assembly reliability, and sufficiently high strength.

The object is achieved according to the invention using a gear unit having the features of claim 1 and an adjustable seat unit having the features of claim 15.

Advantageous embodiments and developments of the invention are specified in the dependent claims.

An inventive gear unit for adjusting a seat, in particular a vehicle seat, in particular longitudinally, comprises a gear mechanism which has a first gear wheel with a first rotational axis and a second gear wheel meshing with the first gear wheel and having a second rotational axis. The gear unit further comprises a housing unit, wherein the housing unit has a gear mechanism housing in which the gear mechanism is arranged and at least one retaining element for establishing a mechanical operative connection between the gear unit and the seat. The at least one retaining element is integrally molded onto the gear mechanism housing. This allows the number of parts to be reduced and a high strength of the gear unit to be achieved.

The entire housing unit is preferably designed in one piece. The housing unit may be manufactured, in particular, by means of a molding manufacturing process, such as deep drawing or extrusion. To establish a mechanical operative connection between the gear unit and the seat, at least one retaining element may have a fastening hole.

The gear mechanism is preferably designed as a worm gear, wherein the first gear wheel is preferably designed as a worm and the second gear wheel as a worm wheel. The first rotational axis and the second rotational axis are preferably arranged at right angles to each other. The second gear wheel is preferably designed as a spindle nut having a spindle shaft. The second gear wheel may also have an internal spindle thread arranged about the spindle axis. The spindle axis is preferably designed to coincide with the second rotational axis. The gear mechanism can thus be driven by means of a threaded spindle in engagement with the worm wheel and is preferably arranged on the spindle axis.

The at least one retaining element may be aligned along the first rotational axis and/or the second rotational axis. The at least one retaining element is preferably aligned along the first rotational axis.

Particularly preferably, the housing unit has two retaining elements of the at least one retaining element, which are integrally molded onto the gear mechanism housing opposite each other. This allows for advantageous support of the gear unit on the seat, considering the two opposing directions of movement of the seat. The two retaining elements are preferably arranged on the gear mechanism housing such that the housing unit has a T-shape with one vertical portion and two horizontal portions. The vertical portion is preferably formed by the gear mechanism housing and the horizontal portions are each formed by one of the retaining elements.

The gear mechanism housing may have an opening formed along an opening axis, in which the gear mechanism is arranged, the opening axis preferably being arranged perpendicular to the first rotational axis and/or the second rotational axis. The opening may be particularly advantageous for the easy assembly of the gear mechanism into the gear mechanism housing transverse to the first rotational axis and/or the second rotational axis.

The opening is preferably designed as a through-opening. Such a design of the opening may be particularly advantageous with regard to the manufacture of the housing unit, but also with regard to the assembly of the gear unit.

In a further development of the invention, the gear unit has a cover insert with a cover closing the opening, wherein the cover insert has at least one first bearing element by means of which the first gear wheel is mounted. The first gear wheel is preferably mounted on a plain bearing. Preferably, the cover insert has two first bearing elements of the at least one first bearing element. The first gear wheel preferably has two first bearing extensions arranged opposite each other on the first rotational axis, each first bearing extension being able to be arranged on one of the first bearing elements. The at least one first bearing element may, in particular, be designed as part of a split bearing seat and thus as a partial bearing seat. The bearing seat is preferably split circumferentially about the first rotational axis.

The cover insert may have at least one support structure which is arranged on the one hand on the at least one first bearing element and on the other hand on the cover. Thus, by means of at least one first bearing element, the first gear wheel can be mounted even if it is arranged at a distance from the cover. This may be the case, in particular, if the second gear wheel is positioned between the cover and the first gear wheel. The cover insert may have two support structures or at least one support structure, in particular if the cover insert has two first bearing elements.

The gear mechanism housing may have at least one bearing groove in which the first gear wheel is mounted. The at least one bearing groove preferably has a groove end. The groove end may be designed as a partial bearing seat. The groove end, together with the at least one first bearing element, can form at least one bearing seat for the first gear wheel. The at least one bearing groove preferably extends in the direction of the horizontal portion from a free end of the vertical portion opposite the horizontal portion of the gear mechanism housing. The gear mechanism housing may have two bearing grooves of at least one bearing groove, one of the first bearing extensions preferably being arranged in each of the bearing grooves.

The at least one support structure is preferably arranged in the at least one bearing groove. This allows the position of at least one first bearing element to be stabilized. It is particularly preferred that the at least one support structure is arranged to close at least one bearing groove.

In one preferred embodiment of the invention, the cover insert has at least one second bearing element, wherein the second gear wheel is mounted by means of the at least one second bearing element. The second gear wheel is preferably mounted on a plain bearing. The cover insert preferably has two second bearing elements of the at least one second bearing element. The second gear wheel preferably has two second bearing extensions arranged opposite each other on the second rotational axis, wherein each second bearing extension may be arranged on one of the second bearing elements. The at least one second bearing element may in particular be designed as part of a split bearing seat and thus as a partial bearing seat. The bearing seat is preferably split circumferentially about the second rotational axis.

The cover insert is preferably formed in one piece. This allows the at least one first bearing element and the at least one second bearing element to be mounted together with the cover in a single assembly step into the gear mechanism housing. The cover insert can preferably be attached in the gear mechanism housing in a form-fitting manner, for example with a pin, rivet or screw connection. Furthermore, it is conceivable to attach the cover insert in the gear mechanism housing by means of an adhesive or welded connection. The at least one support structure with the at least one first bearing element and the at least one second bearing element are preferably integrally molded onto the cover. The cover insert is preferably designed as a plastic injection molded part.

In a further development of the invention, the gear unit has at least one third bearing element, wherein the second gear wheel is mounted by means of the at least one third bearing element, wherein the gear mechanism housing has at least one spindle opening for the threaded spindle to pass through, and wherein the at least one third bearing element can be inserted into the at least one spindle opening. The at least one third bearing element may have a bearing element opening for the threaded spindle to pass through. The at least one third bearing element may, in particular, be designed as part of a split bearing seat and thus as a partial bearing seat. The at least one third bearing element, together with the at least one second bearing element, can form at least one bearing seat of the second gear wheel. The gear unit preferably has two third bearing elements of the at least one third bearing element.

The gear unit may have a bearing bushing, wherein the first gear wheel is mounted on one side by means of the bearing bushing. This allows the position of the first gear wheel to be defined along the first rotational axis. If the first gear has two differently shaped first bearing extensions, these differences can be compensated by means of the bearing bushing in order to be able to mount the first gear wheel with both first bearing extensions in identically shaped bearing grooves. The bearing bushing may be arranged on one of the first bearing extensions.

In a further development of the invention, the gear mechanism housing has a first housing portion in which the first gear wheel is arranged, and a second housing portion in which the second gear wheel is arranged, wherein the opening in the direction of the first rotational axis has a first opening width in the first housing portion and in the second housing portion, and wherein the first opening width is smaller than the second opening width. This allows the first gear wheel to be easily positioned during assembly by inserting the first bearing extensions or the bearing bushing into at least one bearing groove.

The following steps can be carried out to assemble the gear unit, preferably in the order stated:
providing the housing unit,
arranging the first gear wheel in the gear mechanism housing, preferably in the at least one bearing groove,
arranging the second gear wheel in the at least one second bearing element of the cover insert,
arranging the cover insert and the second gear wheel in the gear mechanism housing such that the first gear wheel is mounted by means of the at least one first bearing element.

After arranging the first gear wheel in the gear mechanism housing and before arranging the cover insert and the second gear wheel in the gear mechanism housing, the at least one third bearing element is preferably inserted into the at least one spindle opening. Before arranging the first gear wheel in the gear mechanism housing, the bearing bushing can be arranged on one side of the first gear wheel, in particular, on one of the first bearing extensions. The cover insert and the second gear wheel are preferably arranged in the gear mechanism housing such that the second gear wheel is mounted by means of at least one second bearing element and by means of at least one third bearing element.

An inventive adjustable seat unit, in particular for a vehicle, comprises a seat and a gear unit as described above, wherein the at least one retaining element of the gear unit is attached to a seat rail of the seat. The seat unit may further comprise a threaded spindle in engagement with the second gear wheel designed as a spindle nut. The seat unit preferably has two gear units, two seat rails and two threaded spindles, each designed or arranged accordingly. The seat unit is preferably designed for longitudinal adjustment of the preferably seat.

An exemplary embodiment of the invention is explained using the following figures. In the drawings:

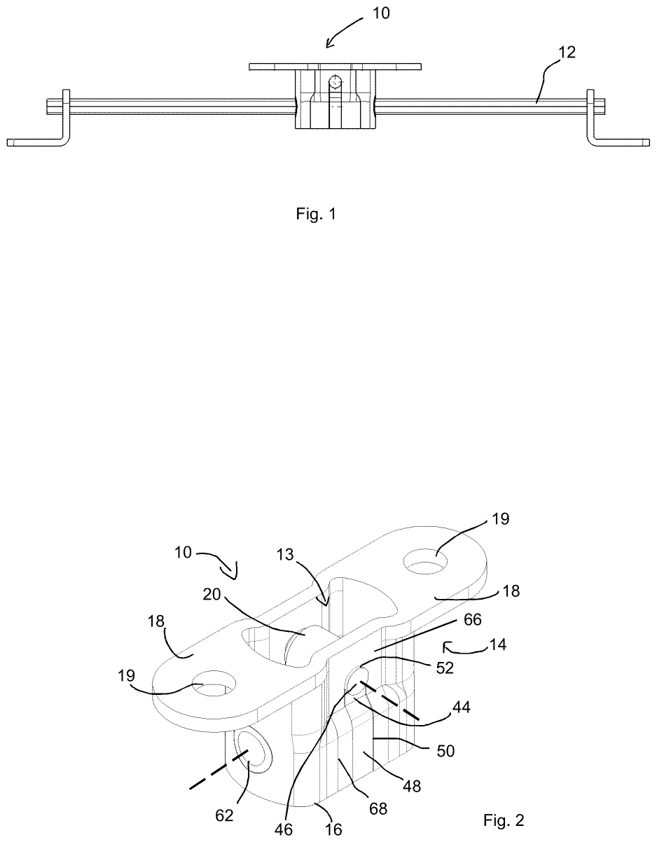

FIG. 1 is a schematic representation of an exemplary embodiment of a gear unit on a threaded spindle;

FIG. 2 is a schematic perspective view of the exemplary embodiment shown in FIG. 1;

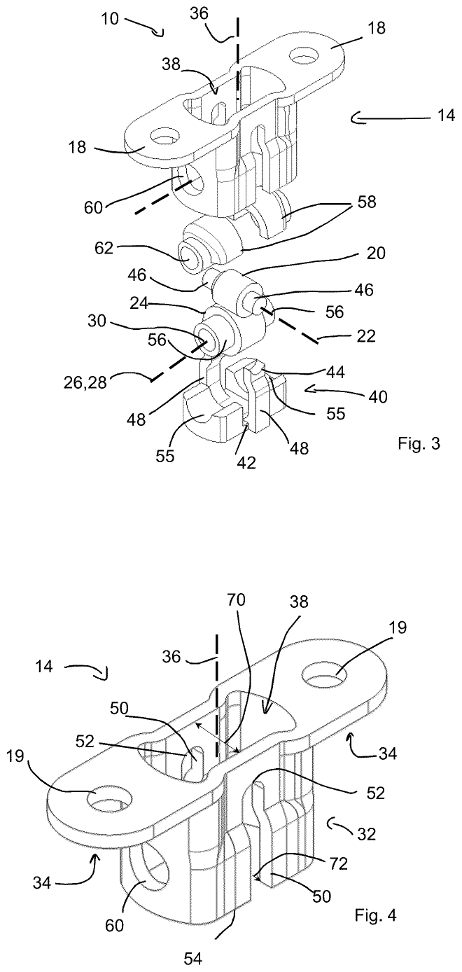

FIG. 3 is a schematic exploded view of the exemplary embodiment shown in FIG. 1;

FIG. 4 is a schematic perspective view of the housing unit of the exemplary embodiment shown in FIG. 1;

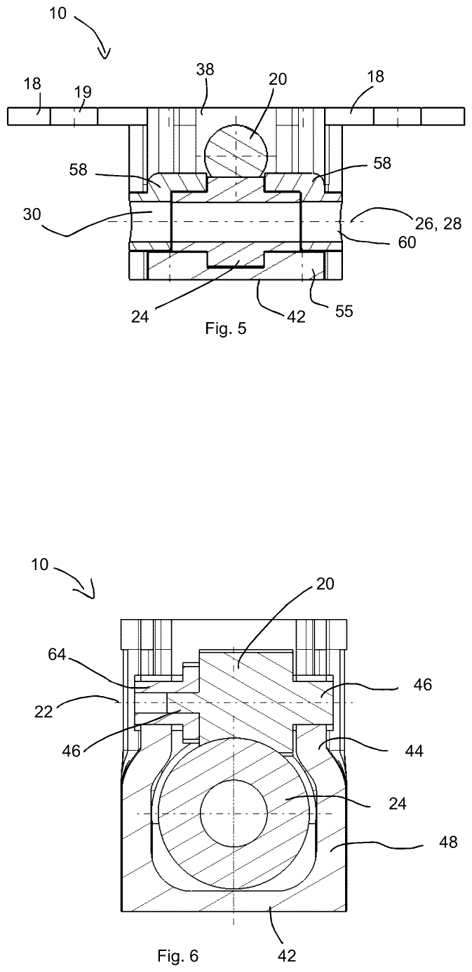

FIG. 5 is a schematic sectional view of the exemplary embodiment shown in FIG. 1 along the second rotational axis; and

FIG. 6 is a schematic sectional view of the exemplary embodiment shown in FIG. 1 along the first rotational axis.

FIGS. 1 to 6 show different views of an exemplary embodiment. For the sake of clarity, not all reference numbers are used in every figure. The same reference numbers are used for identical and functionally identical parts.

FIG. 1 shows an exemplary embodiment of a gear unit 10 for adjusting a seat, in particular a vehicle seat, in particular longitudinally, wherein the gear unit 10 is arranged as part of an adjustable seat unit as intended on a threaded spindle 12. The seat unit preferably has two of the arrangements shown in FIG. 1.

The gear unit 10 is shown separately in FIG. 2. The gear unit 10 comprises a gear mechanism 13 and a housing unit 14, wherein the housing unit 14 has a gear mechanism housing 16, in which the gear mechanism 13 is arranged, and two retaining elements 18 for establishing a mechanical operative connection between the gear unit 10 and the seat. The retaining elements 18 are each integrally molded onto the gear mechanism housing 16.

Overall, the housing unit 14 of the illustrated exemplary embodiment is formed in one piece. A separate illustration of the housing unit 14 can be found in FIG. 4. The housing unit 14 may be manufactured, in particular, by means of a molding manufacturing process, such as deep drawing or extrusion, for example. To establish a mechanical operative connection between the gear unit 10 and the seat, each of the retaining elements has a fastening hole 19.

As shown in the exploded view in FIG. 3, the gear mechanism 13 has a first gear wheel 20 having a first rotational axis 22 and a second gear wheel 24 meshing with the first gear wheel 20 and having a second rotational axis 26. The gear mechanism 13 is designed as a worm gear, wherein preferably the first gear wheel 20 is designed as a worm and the second gear wheel 24 as a worm wheel. The first rotational axis 22 and the second rotational axis 26 are arranged at right angles to each other. The second gear wheel 24 is also designed as a spindle nut having a spindle shaft 28. The second gear wheel 24 has an internal spindle thread 30 arranged about the spindle axis 28. The spindle axis 28 is designed to coincide with the second rotational axis 26. The gear mechanism 13 can thus be driven by means of the threaded spindle 12, which is in engagement with the spindle thread 30 and is arranged on the spindle axis.

As shown in particular in FIG. 3, the retaining elements 18 are aligned along the second rotational axis 26. The two retaining elements 18 are arranged on the gear mechanism housing 16 such that the housing unit 14 has a T-shape with a vertical portion 32 and two horizontal portions 34 (see in particular FIG. 4). The vertical portion 32 is formed by the gear mechanism housing 16 and the horizontal portions 34 are each formed by one of the retaining elements 18.

As can also be seen from FIG. 3, the gear mechanism housing 16, in which the gear mechanism 13 is arranged, has an opening 38 formed along an opening axis 36. The opening axis 36 is arranged perpendicular to the first rotational axis 22 and the second rotational axis 26. In the illustration of FIG. 4, it can be seen that the opening 38 is designed as a through-opening. Such a design of the opening 38 can be particularly advantageous with regard to the manufacture of the housing unit 14 but also with regard to the assembly of the gear unit 10.

FIG. 3 also shows that the gear unit 10 has a cover insert 40 having a cover 42 closing the opening 38. The cover insert 40 has two first bearing elements 44 by means of which the first gear wheel 20 is on mounted on plain bearings. The first gear wheel 20 has two first bearing extensions 46 arranged opposite each other on the first rotational axis 22, each first bearing extension 46 being arranged on one of the first bearing elements 44. Each of the first bearing elements 44 is designed as part of a split bearing seat and thus as a partial bearing seat. The bearing seat is split circumferentially about the first rotational axis 22.

The cover insert 40 has two support structures 48, each of which is arranged on one side on one of the first bearing elements 44 and on the other side on the cover 42. The first gear wheel 20, which is arranged at a distance from the cover 42, can thus be mounted by means of the first bearing element 44. The second gear wheel 24 is arranged between the cover 42 and the first gear wheel 20.

The gear mechanism housing 16 also has two bearing grooves 50 for mounting the first gear wheel 20. To this end, the first gear wheel 20 having the two first bearing extensions 46 is arranged in one of the bearing grooves 50. As illustrated, in particular by FIG. 2, each of the bearing grooves 50 has a groove end 52 designed as a partial bearing seat. Each of the groove ends 52, together with the respective first bearing element 44, forms a bearing seat for the first gear wheel 20. The bearing grooves 50 each extend from a free end 54 of the vertical portion 32 opposite the horizontal portion 34 of the gear mechanism housing 16 in the direction of the horizontal portion 34 (see also FIG. 4). The support structures 48 are arranged in the respective bearing groove 50 such that the respective bearing groove 50 is closed by the corresponding support structure 48.

As shown in FIG. 3, the cover insert 40 has two second bearing elements 55 by means of which the second gear wheel 24 is mounted on a plain bearing. The second gear wheel 24 has two second bearing extensions 56 arranged opposite each other on the second rotational axis 26, wherein each second bearing extension 56 is arranged on one of the second bearing elements 55. The second bearing elements 55 are each designed as part of a bearing seat split circumferentially about the second rotational axis 26 and thus as a partial bearing seat.

The cover insert 40 is made in one piece. In particular, the support structures 48 with the first bearing elements 44 and the second bearing elements are each integrally molded onto the cover 42. Thus, the first bearing elements 44 and the second bearing elements 55 together with the cover 42 can be mounted in the gear mechanism housing 16 in one assembly step. The cover insert 40 is preferably designed as a plastic injection molded part. The cover insert 40 can preferably be attached in a form fit secured in the gear mechanism housing 16, for example with a pin, rivet or screw connection. Furthermore, it is possible to attach the cover insert 40 in the gear mechanism housing 16 by means of an adhesive or welded connection.

The gear unit 10 has two third bearing elements 58. The third bearing elements are also shown in FIG. 3. The second gear wheel 24 is mounted by means of the two third bearing elements 58. The gear mechanism housing 16 has two spindle openings 60 for the threaded spindle 12 to pass through. One of the third bearing elements 58 can be inserted into each of the spindle openings 60. Each of the third bearing elements 58 has a bearing element opening 62 for the threaded spindle 12 to pass through. The third bearing elements 58 are each designed as part of a split bearing seat such that each of the third bearing elements 58, together with each of the second bearing elements 55, forms a bearing seat of the second gear wheel 24.

The sectional view of FIG. 6 shows that the gear unit 10 has a bearing bushing 64, wherein the first gear wheel 20 is mounted on one side by means of the bearing bushing 64. This allows the position of the first gear wheel 20 along the first rotational axis 22 to be defined. Furthermore, it can be seen from FIG. 6 that the first bearing extensions 46 of the first gear wheel 20 are designed differently, in particular in that they have different diameters. Such differences can be compensated by means of the bearing bushing 64 in order to be able to mount the first gear wheel 20 with both first bearing extensions 46 in the identically designed bearing grooves 50. To this end, the bearing bushing 64 is arranged on one of the first bearing extensions 46.

The perspective view of FIG. 2 shows that the gear mechanism housing 16 has a first housing portion 66 in which the first gear wheel 20 is arranged. Furthermore, the gear mechanism housing 16 has a second housing portion 68 in which the second gear wheel 24 is arranged. As illustrated by the separate representation of the housing unit 14 in FIG. 4, the opening 38, in the direction of the first rotational axis 22, has a first opening width 70 in the first housing portion 66 and a second opening width 72 in the second housing portion 68. The first opening width 70 is smaller than the second opening width 72. This allows the first gear wheel 20 to be easily positioned during assembly by inserting the first bearing extensions 46 or the bearing bushing 64 into the respective bearing groove 50.

The preferred assembly of the gear unit 10 can be understood in particular using the exploded view of FIG. 3. The following steps can be carried out, preferably in the order listed:
providing the housing unit 14,
arranging the bearing bushing 64 on one side on one of the first bearing extensions 46 on the first gear wheel 20, arranging the first gear wheel 20 in the gear mechanism housing 16,
inserting the third bearing elements 58 into the spindle openings 60,
arranging the second gear wheel 24 in the second bearing elements 55 of the cover insert 40,
arranging the cover insert 40 and the second gear wheel 24 in the gear mechanism housing 16 such that the first gear wheel 20 is mounted by means of the first bearing elements 44 and the second gear wheel 24 is mounted by means of the second bearing elements 55 and by means of the third bearing elements 58.

### LIST OF REFERENCE SYMBOLS

10 Gear unit
12 Threaded spindle
13 Gearbox
14 Housing unit
16 Gear mechanism housing
18 Retaining element
19 Retaining hole
20 First gear wheel
22 First rotational axis
24 Second gear wheel
26 Second rotational axis
28 Spindle axis
30 Spindle thread
32 Vertical portion
34 Horizontal portion
36 Opening axis
38 Opening
40 Cover insert
42 Cover
44 First bearing element
46 First bearing extension
48 Support structure
50 Bearing groove
52 Groove end
54 Free end
55 Second bearing element
56 Second bearing extension
58 Third bearing element
60 Spindle opening
62 Bearing element opening
64 Bearing bushing
66 First housing portion
68 Second housing portion
70 First opening width
72 Second opening width

1. A gear unit (10) for adjusting a seat, in particular a vehicle seat, in particular longitudinally, with a gear mechanism (13) comprising a first gear wheel (20) with a first rotational axis (22) and a second gear wheel (24) meshing with the first gear wheel (20) and having a second rotational axis (26), and with a housing unit (14), wherein the housing unit (14) comprises
a gear mechanism housing (16) in which the gear mechanism (13) is arranged, and
at least one retaining element (18) for establishing a mechanical operative connection between the gear unit (10) and the seat,
characterized in that the at least one retaining element (18) is integrally molded onto the gear mechanism housing (16).

2. The gear unit (10) according to claim 1, characterized in that the at least one retaining element (18) is aligned along the first rotational axis (22) and/or the second rotational axis (26).

3. The gear unit (10) according to claim 1, characterized in that the housing unit (14) has two retaining elements (18) of the at least one retaining element (18) which are integrally molded onto the gear mechanism housing (16) opposite each other.

4. The gear unit (10) according to claim 1, characterized in that the gear mechanism housing (16) has an opening (38), formed along an opening axis (36), in which the gear mechanism (13) is arranged, the opening axis (36) preferably being arranged perpendicular to the first rotational axis (22) and/or the second rotational axis (26).

5. The gear unit (10) according to claim 4, characterized in that the opening (38) is designed as a through-opening.

6. The gear unit (10) according to claim 4, characterized in that the gear unit (10) has a cover insert (40) with a cover (42) closing the opening (38), wherein the cover insert (40) has at least one first bearing element by means of which the first gear wheel (20) is mounted.

7. The gear unit (10) according to claim 6, characterized in that the cover insert (40) has at least one support structure (48) which is arranged on the one hand on the at least one first bearing element and on the other hand on the cover (42).

8. The gear unit (10) according to claim 1, characterized in that the gear mechanism housing (16) has at least one bearing groove

(50) in which the first gear wheel (20) is mounted.

9. The gear unit (10) according to claim 7, characterized in that the at least one support structure (48) is arranged in the at least one bearing groove (50).

10. The gear unit (10) according to claim 6, characterized in that the cover insert (40) has at least one second bearing element (55), wherein the second gear wheel (24) is mounted by means of the at least one second bearing element (55).

11. The gear unit (10) according to claim 6, characterized in that the cover insert (40) is formed in one piece.

12. The gear unit (10) according to claim 1, characterized in that the gear unit (10) has at least one third bearing element (58), wherein the second gear wheel (24) is mounted by means of the at least one third bearing element (58), wherein the gear mechanism housing (16) has at least one spindle opening (60) for a threaded spindle (12) to pass through, and wherein the at least one third bearing element (58) can be inserted into the at least one spindle opening (60).

13. The gear unit (10) according to claim 1, characterized in that the gear unit (10) has a bearing bushing (64), wherein the first gear wheel (20) is mounted on one side by means of the bearing bushing (64).

14. The gear unit (10) according to claim 4, characterized in that the gear mechanism housing (16) has a first housing portion (66) in which the first gear wheel (20) is arranged, and a second housing portion (68) in which the second gear wheel (24) is arranged, wherein the opening (38) in the direction of the first rotational axis (22) in the first housing portion (66) has a first opening width (70) and in the second housing portion (68) has a second opening width (72), and wherein the first opening width (70) is smaller than the second opening width (72).

15. An adjustable seat unit, in particular for a vehicle, comprising a seat and a gear unit (10) according to any of the preceding claims, wherein the at least one retaining element (18) of the gear unit (10) is attached to a seat rail of the seat.
